(19) United States
(12) Patent Application Publication
(10) Pub. No.: US 2025/0219078 A1
(43) Pub. Date: Jul. 3, 2025

(54) POSITIVE ELECTRODE INCLUDING LiFexMn1-xPO4-BASED POSITIVE ELECTRODE ACTIVE MATERIAL AND LITHIUM SECONDARY BATTERY INCLUDING THE SAME

(71) Applicant: KNU-Industry Cooperation Foundation, Chuncheon-si (KR)

(72) Inventors: Youngjin KIM, Chuncheon-si (KR); Sieun Choi, Seoul (KR); Inhye Kim, Chuncheon-si (KR); Seonghyeon Hong, Chuncheon-si (KR); Jeongha Seo, Chuncheon-si (KR); Seungwon Shin, Gangneung-si (KR); Younghyun Hong, Guri-si (KR); Jun Young Cheong, Bayreuth (DE); Jinseok Park, Chuncheon-si (KR)

(21) Appl. No.: 18/782,234

(22) Filed: Jul. 24, 2024

(30) Foreign Application Priority Data
Jan. 3, 2024 (KR) 10-2024-0000917

(51) Int. Cl. H01M 4/58; H01M 4/02; H01M 4/04; H01M 4/36; H01M 4/62; H01M 10/0525

(52) U.S. Cl. CPC H01M 4/5825; H01M 4/0404; H01M 4/366; H01M 4/621; H01M 10/0525; H01M 2004/028

(57) ABSTRACT

The present invention relates to an LFMP-based positive electrode active material for a lithium secondary battery, provided with excellent capacity and lifetime characteristics, and a secondary battery including the same, and specifically, relates to an LFMP-based positive electrode active material for a lithium secondary battery, provided with excellent capacity and long life characteristics due to the composition of the LFMP-based positive electrode active material and structural characteristics of a positive electrode including the same, and a lithium secondary battery including the same.

### CROSS-REFERENCE TO RELATED APPLICATION

This application claims priority to Korean Patent Application No. 10-2024-0000917, filed on Jan. 3, 2024, and all the benefits accruing therefrom under 35 U.S.C. § 119, the contents of which are incorporated by reference in their entirety.

### BACKGROUND

The present disclosure relates to a positive electrode containing a LiFeₓMn₁₋ₓPO₄-based positive electrode active material and a lithium secondary battery, provided with excellent capacity retention, lifetime characteristics, and speed characteristics.

Demand for secondary batteries as an energy source is on a rapid rise, resulting from technology development and a growing demand for mobile devices. Among such secondary batteries, lithium secondary batteries having high energy density and voltage, long cycle life, and low self-discharging rate have been commercially available and widely used.

Lithium transition metal composite oxides have been used as a positive electrode active material of the lithium secondary batteries, and in particular, a lithium cobalt composite metal oxide, such as LiCoO₂, having a high working voltage and excellent capacity characteristics has been primarily used. However, LiCoO₂ has fairly poor thermal properties due to due to an unstable crystal structure caused by delithiation and is expensive, and accordingly, has a limitation in being used as a power source in an area such as electric vehicles in a large amount.

Lithium manganese-based oxides (LiMnO₂, LiMn₂O₄, or the like), lithium iron phosphate compounds (LiFePO₄ and the like), lithium nickel composite metal oxides (LiNiO₂ and the like), or the like have been developed as materials for replacing LiCoO₂. In particular, the lithium manganese-based oxides have an issue of exhibiting reduced stability due to low oxidation stability at high voltage, and also have an issue of having poorer output characteristics than typically used positive electrode active materials.

Therefore, there is a need for the development of lithium manganese-based oxides capable of providing improved structural stability and output characteristics.

### SUMMARY

The present disclosure is designed to address the technical tasks described above, and thus the present disclosure provides a positive electrode containing a LiFeₓMn₁₋ₓPO₄-based positive electrode active material, which may exhibit excellent lifetime and speed characteristics, and a lithium secondary battery including the positive electrode.

Aspects of the present disclosure are not limited to the above-described aspects, and other tasks and benefits of the present disclosure that are not described may be appreciated from the following descriptions, and more clearly appreciated from embodiments of the present invention. Further, it will be easily appreciated that the aspects and benefits of the present disclosure may be practiced by features recited in the appended claims and a combination thereof.

To address the technical tasks described above, in accordance with an exemplary embodiment of the present invention, a positive electrode for a lithium secondary battery includes a carbon layer formed on a positive electrode current collector and a positive electrode active material layer formed on the carbon layer, wherein the positive electrode active material layer includes a positive electrode active material according to Formula 1 below, and carbon content contained in the carbon layer and the positive electrode active material layer satisfies Relation 1 below.

LiFe_{1-x-y}MnₓM_{y}PO₄ [Formula 1]

In Formula 1 above, M is at least one metal element selected from the group consisting of Mg, Al, Zn, and Ni, and 0<x<1 and 0≤y<0.1 are satisfied.

$$2 \leq {C}_{1} / {C}_{2} \leq 4 \qquad [ Relation 1 ]$$

In Relation 1 above, C₁ indicates carbon content contained in the carbon layer and C₂ indicates carbon content contained in the positive electrode active material layer.

In an embodiment of the present invention, the carbon layer may have a thickness of 1 nm to 1,000 nm.

In an embodiment of the present invention, the positive electrode active material layer may have a thickness of 10 μm to 100 μm.

In an embodiment of the present invention, the carbon layer may include at least one carbon material selected from the group consisting of natural graphite, artificial graphite, super P, acetylene black, Ketjen black, channel black, furnace black, lamp black, thermal black, denka black, carbon black, graphene, and carbon nanotubes.

In an embodiment of the present invention, the positive electrode active material layer may include the positive electrode active material, a conductive material, and a binder.

In an embodiment of the present invention, the conductive material contained in the positive electrode active material layer and a carbon material contained in the carbon layer may be different.

In an embodiment of the present invention, the positive electrode active material layer and the carbon layer may be present at a thickness ratio of 20:1 to 200:1.

In accordance with another exemplary embodiment of the present invention, a lithium secondary battery includes the positive electrode for a lithium secondary battery according to the present invention, a negative electrode, an electrolyte, and a porous separator placed between the positive electrode and the negative electrode.

The means for addressing the above tasks do not present all the characteristics of the present invention. The various characteristics of the present invention and benefits and effects thereof may be understood in more detail with reference to specific examples below.

### BRIEF DESCRIPTION OF THE DRAWINGS

Exemplary embodiments can be understood in more detail from the following description taken in conjunction with the accompanying drawings, in which:

FIG. 1 shows the XRD results of an LFMP-based positive electrode active material in accordance with an embodiment of the present invention;

FIG. 2 is an FE-SEM image of an LFMP-based positive electrode active material;

FIG. 3 is a cross-sectional FE-SEM image of a carbon layer formed on a positive electrode current collector in accordance with an embodiment of the present invention;

FIG. 4 is a cross-sectional FE-SEM image of a positive electrode containing an LFMP-based positive electrode active material in accordance with an embodiment of the present invention;

FIG. 5 is a cross-sectional FE-SEM image of a positive electrode containing an LFMP-based positive electrode active material according to Comparative Example;

FIG. 6 shows cross-sectional FE-SEM images of positive electrodes according to Example 1 and Comparative Example 1, and the distribution of carbon elements in a carbon layer (arrow) and a positive electrode active material layer included in each positive electrode, analyzed by energy-disperse x-ray spectroscopy (EDS);

FIG. 7 shows a first cycle voltage-capacity graph (charge/discharge curve) of a half-cell prepared in Experimental Example;

FIG. 8 shows capacity retention when charging/discharging is performed at a rate of 1 C using a half-cell prepared in Experimental Example;

FIGS. 9 and 10 show voltage-capacity graphs (charge/discharge curves) according to the cycle of a half-cell prepared in Experimental Example; and

FIGS. 11 and 12 show voltage-capacity graphs (charge/discharge curves) obtained by varying the C-rate for a half-cell prepared in Experimental Example.

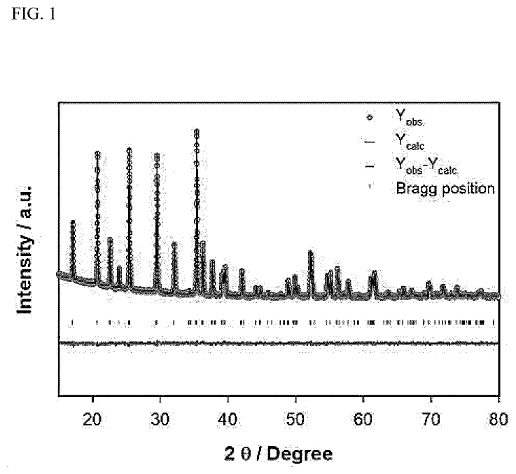

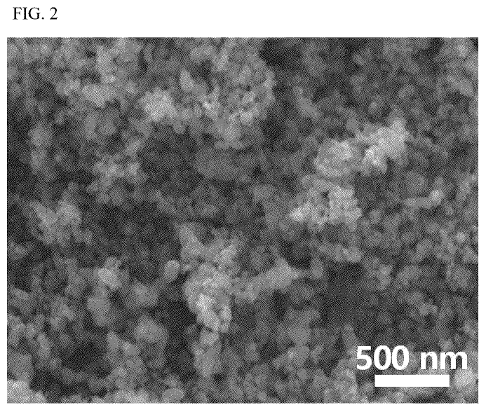

### DETAILED DESCRIPTION OF EMBODIMENTS

Hereinafter, principles of preferred embodiments of the present disclosure will be described in detail with reference to the accompanying drawings and descriptions. However, the drawings shown below and the following descriptions are for preferred methods among various methods, for effectively describing characteristics of the present disclosure, and the present disclosure is not limited only to the following drawings and descriptions.

Meanwhile, although terms such as first, second, and the like may be used herein to describe various elements, these terms are used merely to distinguish one element from another element. For example, a first element may be referred to as a second element, and similarly, a second element may be referred to as a first element.

The singular forms are intended to include the plural forms as well, unless the context clearly indicates otherwise. As used herein, it should be understood that the terms “comprise” or “have” are intended to specify the presence of stated features, integers, processes, operations, elements, components, or combinations thereof, but do not preclude the presence or addition of one or more other features, integers, processes, operations, elements, components, or combinations thereof.

Unless defined otherwise, all the terms used herein, including technical or scientific terms, may have the same meanings as those commonly understood by those skilled in the art. Terms that are defined in a commonly used dictionary should be construed as having meanings consistent with the meanings in the context of the related art, and should meaning not be construed as having an ideal or overly formal meaning unless explicitly defined herein.

In describing the present invention, the numerical range indicated by using “to” represents a numerical range including the values described therebefore and thereafter as a lower limit and an upper limit, respectively. When a plurality of numerical values each for the upper and lower limits of any numerical range are disclosed, the numerical range disclosed herein may be understood as any numerical range in which any one of the plurality of lower limit values and any one of the plurality of upper limit values are each set as a lower limit and an upper limit.

Hereinafter, specific components and effects of the present invention will be described in more detail with the accompanying drawings.

### 1. Positive Electrode

A positive electrode for a lithium secondary battery according to the present invention includes a carbon layer formed on a positive electrode current collector and a positive electrode active material layer formed on the carbon layer and containing a LiFe_{1-x-y}MnₓM_{y}PO₄-based positive electrode active material.

In an embodiment of the present invention, the carbon layer may include at least one carbon material selected from the group consisting of natural graphite, artificial graphite, super P, acetylene black, Ketjen black, channel black, furnace black, lamp black, thermal black, denka black, carbon black, graphene, and carbon nanotubes. In addition, the carbon layer may be formed of a carbon material different from the carbon (corresponding to a conductive material) contained in the positive electrode active material layer, which will be described later.

Herein, the carbon layer is placed between the positive electrode active material layer and the positive electrode current collector to reduce the resistance of electron transfer, and the reduced resistance of batteries may allow excellent capacity retention, lifetime characteristics, and output characteristics.

Lithium iron phosphate-based positive electrode active materials have low electronic conductivity and are thus subjected to carbon coating for improving conductivity to be used. Herein, a carbon layer is found to show greater electrochemical performance than a carbon-coated lithium iron phosphate positive electrode active material when the carbon layer is formed between a current collector and a positive electrode active material layer instead of the carbon-coated lithium iron phosphate positive electrode active material, thereby completing the present invention.

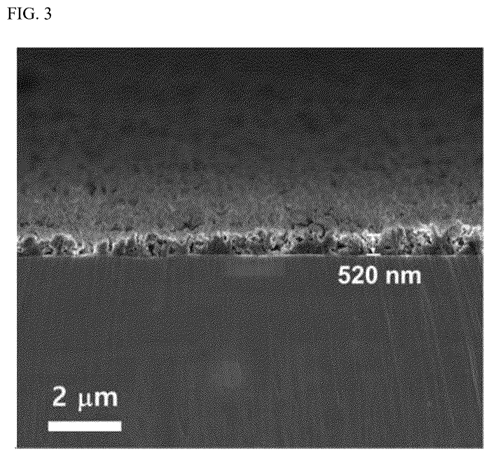

FIG. 3 is a cross-sectional FE-SEM image of a carbon layer formed on a positive electrode current collector according to an embodiment of the present invention. It is seen that a carbon layer having a thickness of about 520 nm is formed on a positive electrode current collector.

In an embodiment of the present invention, the carbon layer may have a thickness of 1 nm to 2,000 nm, preferably 10 nm to 1,000 nm, and when the carbon layer has a thickness of 2,000 nm or greater, charge transfer resistance becomes greater due to the thickness, which is not desirable.

In an embodiment of the present invention, the LiFe_{1-x-y}MnₓM_{y}PO₄-based positive electrode active material included in the positive electrode active material layer includes a compound represented by Formula 1 below.

LiFe_{1-x-y}MnₓM_{y}PO₄ [Formula 1]

In Formula 1 above, M is at least one metal element selected from the group consisting of Mg, Al, Zn, and Ni, and 0<x<1 and 0≤y<0.1 are satisfied.

In a preferred embodiment of the present invention, in Formula 1 above, x may satisfy 0.1≤x≤0.8 and y may satisfy 0≤y≤0.1.

Preferably, the positive electrode active material may have a composition of LiFe_{0.3}Mn_{0.7}PO₄. When x is greater than 0.8, with a decrease in iron content, manufacturing costs may increase and energy density may decrease. When x is less than 0.1, with a decrease in manganese content, the positive electrode active material may have reduced energy density.

The LiFe_{1-x-y}MnₓM_{y}PO₄-based positive electrode active material included in the positive electrode active material layer may be carbon-coated. Preferably, the positive electrode active material may be carbon-coated in a weight range of 0.5 wt % to 4.0 wt % with respect to the weight of the LiFe_{1-x-y}MnₓM_{y}PO₄-based positive electrode active material.

A positive electrode slurry including the LiFe_{1-x-y}MnₓM_{y}PO₄-based positive electrode active material, a conductive material, and a binder may be applied onto the carbon layer formed on the current collector to form the positive electrode active material layer.

In an embodiment of the present invention, the LiFe_{1-x-y}MnₓM_{y}PO₄-based positive electrode active material may be in an amount of 80 wt % or greater, or 80 wt % to 97 wt %, with respect to the total weight of solids in the positive electrode slurry.

The binder may suppress separation between positive electrode active material particles or between the positive active material and the current collector. As the binder, polymers commonly used in electrodes in the art may be used. The binder may be at least one compound selected from the group consisting of poly(vinylidene fluoride co-hexafluoropropylene), poly(vinylidene fluoride-co-trichloroethylene), poly(methylmethacrylate), poly(ethylhexylacrylate), polybutylacrylate, poly(acrylonitrile), poly(vinylpyrrolidone), poly(vinyl acetate), poly(ethylene-co-vinyl acetate), poly(ethylene oxide), polyacrylate, cellulose acetate, cellulose acetate butyrate, cellulose acetate propionate, cyano ethyl pullulan, cyano ethyl poly(vinylalcohol), cyanoethylcellulose, cyano ethylsucrose, pullulan, and carboxyl methyl cellulose, but is not limited thereto.

In an embodiment of the present invention, the binder may be in an amount of 2 wt % to 10 wt % with respect to the total weight of solids in the positive electrode slurry.

The conductive material may preferably be at least one selected from the group consisting of natural graphite, artificial graphite, super P, acetylene black, Ketjen black, channel black, furnace black, lamp black, thermal black, denka black, carbon black, graphene, and carbon nanotubes.

In an embodiment of the present invention, the conductive material may be in an amount of 1 wt % to 30 wt % with respect to the total weight of solids in the positive electrode slurry.

In an embodiment of the present invention, the positive electrode current collector is not particularly limited as long as it has a high conductivity without causing chemical changes in batteries. Specifically, copper, stainless steel, aluminum, nickel, titanium, fired carbon, copper or stainless steel that is surface-treated with one of carbon, nickel, titanium, silver, and the like, an aluminum-cadmium alloy, and the like may be used. The most preferred positive electrode current collector may be aluminum foil, and may typically have a thickness of 6 μm to 20 μm.

Meanwhile, in an embodiment of the present invention, carbon content in the carbon layer and the positive electrode active material layer may satisfy Relation 1 below.

$$2 \leq {C}_{1} / {C}_{2} \leq 4 \qquad [ Relation 1 ]$$

In Relation 1 above, C₁ indicates carbon content contained in the positive electrode active material layer, and C₂ indicates carbon content contained in the carbon layer. In this case, the carbon content indicates weight ratio.

The carbon content may be measured through energy-disperse x-ray spectroscopy (EDS).

In Relation 1, when C₁/C₂ is less than 2, resistance may not be sufficiently reduced due to the low carbon content, and when C₁/C₂ is greater than 4, the carbon content increases, resulting in reduced energy density per weight when using the positive electrode of the present invention, and resistance of batteries may rather increase due to the thick carbon layer.

In an embodiment of the present invention, C₂ may indicate the carbon content contained in a center portion of the positive electrode active material layer.

In this case, the center portion of the positive electrode active material layer may indicate an area having a thickness of +30% or −30%, preferably +20% or −20% in the middle of the positive active material layer, with respect to the total thickness. For example, when the positive active material layer may have a thickness of 10 μm, the center portion may have a thickness of 3 μm to 7 μm, which is an area with a thickness of 2 μm upward and downward from 5 μm, which is the middle of 10 μm, and this C₂ may indicate the carbon content contained in 3 μm to 7 μm.

In another embodiment of the present invention, the carbon layer and the positive active material layer may at a thickness ratio of 1:20 to 1:200. When the carbon layer and the positive active material layer are at a thickness ratio of greater than 1:200, the carbon layer may become too thin, and thus the internal resistance of batteries may not be sufficiently reduced due to the low carbon content, and when the thickness ratio is less than 1:20, the carbon layer may become excessively thick, and thus energy density per weight of batteries is reduced and charge transfer resistance is increased, which is not desirable.

### 2. Secondary Battery

The present invention provides a lithium secondary battery including the positive electrode of the present invention, a negative electrode, an electrolyte, and a porous separator placed between the positive electrode and the negative electrode.

### Negative Electrode

The lithium secondary battery according to the present invention includes a negative electrode current collector and a negative electrode active material layer formed on the negative electrode current collector, and the negative electrode current collector may serve as a path to transfer electrons from the outside so that an electrochemical reaction takes place in the negative electrode active material, or to receive electrons from the negative electrode active material and send the electrons to the outside.

For example, copper, stainless steel, aluminum, nickel, titanium, fired carbon, or aluminum or stainless steel that is surface-treated with one of carbon, nickel, titanium, silver, or the like may be used as the negative electrode current collector, and specifically a transition metal that adsorbs carbon well, such as copper or nickel, may be used as the current collector. For example, the negative electrode current collector may have a thickness of 6 μm to 20 μm, but the thickness of the negative electrode current collector is not limited thereto.

A negative electrode slurry containing a binder and a conductive material along with the negative electrode active material may be applied onto the negative electrode current collector to form the negative electrode active material layer.

The negative electrode active material may serve to store or release lithium ions. A compound capable of reversibly intercalating and deintercalating lithium may be used as the negative electrode active material, and specifically the negative electrode active material may be, for example, a carbonaceous material such as artificial graphite, natural graphite, graphitized carbon fiber, or amorphous carbon; a metallic compound alloyable with lithium, such as Si, Al, Sn, Pb, Zn, Bi, In, Mg, Ga, Cd, a Si alloy, a Sn alloy, or an Al alloy; a metal oxide capable of doping and dedoping lithium, such as SiO_{β}(0<β<2), SnO₂, vanadium oxide, or lithium vanadium oxide; or a composite including the metallic compound and the carbonaceous material, such as a Si—C composite or a Sn—C composite, which may be used alone or in combination of two or more thereof. In addition, a metallic lithium thin film may be used as the negative electrode active material. In addition, as the carbonaceous material, low crystalline carbon, high crystalline carbon, and the like may all be used. Typical examples of the low crystalline carbon may be soft carbon and hard carbon, and typical examples of the high crystalline carbon may be irregular, planar, flaky, spherical, or fibrous natural graphite or artificial graphite, Kish graphite, pyrolytic carbon, mesophase pitch-based carbon fibers, meso-carbon microbeads, mesophase pitches, and high-temperature fired carbon such as petroleum or coal tar pitch derived cokes.

The negative electrode active material may be included in an amount of 80 parts by weight to 99 parts by weight with respect to a total weight of 100 parts by weight of the negative electrode active material layer.

The conductive material serves to improve conductivity between negative electrode active material particles or with metal current collectors in the negative electrode and to make up for the negative electrode binder acting as a nonconductor. The negative electrode conductive material may be, for example, one type of conductive material selected from the group consisting of graphite, carbon black, carbon fiber, metal fiber, metal powder, conductive whisker, conductive metal oxide, activated carbon, and polyphenylene derivative, or a mixture of two or more conductive materials therefrom, and more specifically, the negative electrode conductive material may be one type of conductive material selected from the group consisting of natural graphite, artificial graphite, super-p, acetylene black, Ketjen black, channel black, furnace black, lamp black, thermal black, denka black, aluminum powder, nickel powder, zinc oxide, potassium titanate, and titanium oxide, or a mixture of two or more conductive materials therefrom.

The binder may suppress separation between negative electrode active material particles or between the negative electrode active material layer and the negative electrode current collector. As the negative electrode binder, polymers commonly used in electrodes in the art may be used. The negative electrode binder may be poly(vinylidene fluoride co-hexafluoropropylene), poly(vinylidene fluoride-co-trichloroethylene), poly(methylmethacrylate), poly(ethylhexylacrylate), polybutylacrylate, poly(acrylonitrile), poly(vinylpyrrolidone), poly(vinyl acetate), poly(ethylene-co-vinyl acetate), poly(ethylene oxide), polyacrylate, cellulose acetate, cellulose acetate butyrate, cellulose acetate propionate, cyano ethyl pullulan, cyano ethyl poly(vinylalcohol), cyanoethylcellulose, cyano ethylsucrose, pullulan, and carboxyl methyl cellulose, but is not limited thereto.

### Porous Separator

The porous separator according to the present invention includes a porous substrate to electrically insulate the negative electrode and the positive electrode so as to prevent short circuit.

As a constituent material of the porous substrate, any organic or inorganic material having electrical insulation properties may be used without specific limitation. The porous substrate may include, for example, at least any one selected from the group consisting of polyolefin, polyethylene terephthalate, polybutylene terephthalate, polyacetal, polyamide, polycarbonate, polyimide, polyetheretherketone, polyethersulfone, polyphenylene oxide, polyphenylene sulfide, and polyethylene naphthalene, and may specifically include polyolefin. The polyolefin has excellent applicability, and may also thin a separator and thus increase the proportion of an electrode active material layer in batteries to increase capacity per volume. Specifically, the polyolefin may have a weight average molecular weight (M_{w}) of 100,000 to 500,000 g/mol. When the weight average molecular weight of the polyolefin is less than the above numerical range, sufficient mechanical properties may hardly be obtained, and when the weight average molecular weight is greater than the above numerical range, a shutdown function may not be implemented or molding may hardly be available. The shutdown function indicates a function that dissolves thermoplastic resins and closes pores of the porous substrate when the temperature of secondary batteries increases, and thus blocks the movement of ions and prevents thermal runaway of the batteries.

The porous substrate may have a thickness of, for example, 3 μm to 12 μm or 5 μm to 12 μm. When the thickness of the porous substrate is less than the numerical range, the function of a conductive barrier may not be sufficient, and when the thickness is greater than the numerical range, the resistance of the separator may excessively increase.

The pores included in the porous substrate may have an average diameter of, for example, 10 nm to 100 nm. The pores included in the porous substrate have a structure in which the pores are connected, thereby allowing gas or liquid to pass from one surface of the porous substrate to the other surface thereof.

According to some embodiments of the present invention, a coating layer may be disposed on at least one surface of the porous substrate. Specifically, the coating layer may improve the mechanical strength and heat resistance of the separator and increase ionic conductivity in secondary batteries.

The coating layer according to the present invention may include a binder polymer and inorganic particles.

The binder polymer according to the present invention may connect and stably fix inorganic particles. The binder polymer may be, for example, one type or a mixture of two or more types selected from the group consisting of polyvinylidene fluoride-co-hexafluoropropylene, polyvinylidene fluoride-co-trichloroethylene, polymethylmethacrylate, polyacrylonitrile, polyvinylpyrrolidone, polyvinylacetate, poly(ethylene-co-vinyl acetate), polyethylene oxide, cellulose acetate, cellulose acetate butyrate, cellulose acetate propionate, cyanoethylpullulan, cyanoethylpolyvinylalcohol, cyanoethylcellulose, cyanoethylsucrose, pullulan, carboxyl methyl cellulose, acrylonitrile-styrene butadiene copolymer, polyimide, and styrene-butadiene rubber.

According to another embodiment of the present invention, the weight ratio of the inorganic particles and the binder polymer (inorganic particles: binder polymer) may be 50:50 to 99:1, and specifically 70:30 to 95:5. When the content ratio of the inorganic particles to the binder polymer is less than the above numerical range, the content of the binder polymer increases, and thus the thermal safety improvement performance of the separator may be reduced and a decrease in the empty space formed between the inorganic particles may result in a decrease in pore size and porosity, causing degradation in performance of final batteries, and when the content ratio is greater than the above numerical range, the content of the binder polymer is too small and may thus reduce the pilling resistance of the coating layer.

The inorganic particles according to the present invention may contribute to improving the mechanical strength and heat resistance of the separator for secondary batteries. Specifically, the inorganic particles are not particularly limited as long as they are electrochemically stable. That is, the inorganic particles that may be used herein are not particularly limited as long as they do not cause oxidation and/or reduction reactions in the applied operating voltage range (e.g., 0 to 5 V with respect to Li/Li+) of secondary batteries.

As an example, when inorganic particles having a high dielectric constant are used as the inorganic particles, the degree of dissociation of electrolyte salts, such as lithium salts, in a liquid electrolyte is increased, and accordingly, the electrolyte may have improved ionic conductivity. For the reasons described above, the inorganic particles may be inorganic particles having a dielectric constant of 5 or greater, inorganic particles capable of transferring lithium ions, or a mixture thereof.

The inorganic particles having a dielectric constant of 5 or greater may be one type or a mixture of two or more types selected from the group consisting of Al₂O₃, SiO₂, ZrO₂, AlO(OH), Al(OH)₃, Mg(OH)₂, BaSO₄, TiO₂, BaTiO₃, Pb(ZrₓTi₁₋ₓ)O₃ (PZT, in this case, 0<x<1), Pb₁₋ₓLaₓZr_{1-y}Ti_{y}O₃(PLZT, in this case, 0<x<1, 0<y<1), (1-x)Pb(Mg_{1/3}Nb_{2/3})O₃₋ₓPbTiO₃ (PMN-PT, in this case, 0<x<1), HfO₂, SrTiO₃, SnO₂, CeO₂, MgO, NiO, CaO, ZnO, and SiC.

The inorganic particles capable of transferring lithium ions may be one type or a mixture of two or more types selected from the group consisting of lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y}-based glass (0<x<4, 0<y<13), lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), lithium nitride (LiₓN_{y}, 0<x<4, 0<y<2), SiS2-based glass (LiₓSi_{y}S_{z}, 0<x<3, 0<y<2, 0<z<4), and P₂S₅-based glass (LiₓP_{y}S_{z}, 0<x<3, 0<y<3, 0<z<7).

For example, the average particle diameter (D₅₀) of the inorganic particles may be 1 nm to 10 μm, specifically 10 nm to 2 μm, more specifically 50 nm to 1 μm for the formation of a coating layer having a uniform thickness and an appropriate porosity. The “average particle diameter (D₅₀)” indicates a particle size at a point corresponding to 50% of a particle number cumulative distribution according to particle size. The average particle diameter may be measured using a laser diffraction method. Specifically, powders to be measured are dispersed in a dispersion medium, the dispersed powders are introduced to a commercially available laser diffraction particle size measuring apparatus (e.g., Microtrac 53500), and a difference of diffraction pattern according to the particle size is measured when particles pass through a laser beam, thereby calculating a particle size distribution.

### Electrolyte

The electrolyte according to the present invention may include a solvent and a lithium salt.

The solvent according to the present invention may be, for example, one type or a mixture of two or more types selected from the group consisting of propylene carbonate (PC), ethylene carbonate (EC), diethyl carbonate (DEC), dimethyl carbonate (DMC), dipropyl carbonate (DPC), dimethylsulfoxide, acetonitrile, dimethoxyethane, diethoxyethane, tetrahydrofuran, N-methyl-2-pyrrolidone (NMP), ethylmethyl carbonate (EMC), gamma-butyrolactone (GBL), fluoroethylene carbonate (FEC), methyl formate, ethyl formate, propyl formate, methyl acetate, ethyl acetate, propyl acetate, pentyl acetate, methyl propionate, ethyl propionate, and butyl propionate.

The lithium salt according to the present invention may include, for example, anions such as NO³⁻, F⁻, Cl⁻, Br⁻, I⁻, and PF₆⁻.

The electrolyte according to the present invention may further include an additive, and as the additive that may be used herein, vinylene carbonate (VC), vinyl ethylene carbonate (VEC), fluoroethylene carbonate (FEC), lithium difluorophosphate (LiPO2F2), lithium bis(oxalato)borate (LiBOB), lithium difluoro(oxalato)borate (LiFOB), lithium bis(fluorosulfonyl)imide (LiFSI), lithium bis(trifluoromethanesulfonyl)imide (LiTFSI), lithium difluoro bisoxalato phosphate (WCA), lithium bis(pentafluoroethylsulfonyl)amide (LiBETI), 1,3-propane sultone, 1,3-propene sultone, biphenyl, cyclohexyl benzene, 4-fluorotoluene, succinic anhydride, ethylene sulfate anhydride, tris(methylsilyl)borate, cyclic sulfite, saturated sultone, unsaturated sultone, acyclic sulfone, and the like may each be used alone or in a combination of two or more. The additive may be included in an amount of 0.5 wt % to 10 wt % with respect to the total weight of the electrolyte.

### Applications

The lithium secondary battery according to the present invention may be a cylindrical type secondary battery, a prismatic type secondary battery, and a pouch type secondary battery, but the lithium secondary battery is not particularly limited thereto as long as it corresponds to a charge/discharge device.

Another embodiment of the present invention may provide a battery module including the secondary battery as a unit cell and a battery pack including the battery module. The battery pack may be, for example, used as a power source of at least one medium and large sized device selected from the group consisting of a power tool; electric cars including an electric vehicle (EV), a hybrid electric vehicle (HEV), and a plug-in hybrid electric vehicle (PHEV); or a power storage system.

Hereinafter, the effects of the present invention will be described in detail through specific examples and experimental results. Examples shown below are presented only for the specific understanding of embodiments of the present invention, and the scope of the present invention is not limited thereto. Those skilled in the art who read the present description may implement the present invention by adding other components or deleting or substituting non-essential components, except for the essential components of the present invention, and this is readily apparent from the description herein, and it should be understood that such embodiments are also within the scope of the present invention.

### EXAMPLE

### Preparation of Positive Electrode

### Example 1

Distilled water and alcohol were added in an appropriate ratio to a mixture in which carbon material, SBR, and CMC were mixed in a weight ratio of 1:1:1 to prepare a slurry, and the slurry was applied onto an aluminum current collector and dried at about 120° C. to form a carbon layer according to the present invention.

N-methyl-2-pyrrolidone (NMP) was added to a mixture in which a positive electrode active material (LiFe_{0.3}Mn_{0.7}PO₄), a conductive material (Super-P), and polyvinylidene fluoride (PVDF) were mixed in a weight ratio of 96:2:2 to prepare a positive electrode slurry.

The positive electrode slurry was applied onto a surface of the dried carbon layer and dried at 120° C. to form a positive electrode active material layer, and a positive electrode according to the present invention was prepared.

### Examples 2 to 5

Positive electrodes of Examples 2 to 5 were prepared in the same manner as in Example 1, except that the contents of the components in the positive electrode active material layer and the carbon layer were prepared as shown in Table 1 below.

### Comparative Example 1: Preparation of Lithium Secondary Battery without Carbon Layer

A positive electrode was prepared in the same manner as in Example 1, except that a positive electrode slurry was directly applied onto a surface of aluminum foil without forming a carbon layer to prepare a positive electrode.

TABLE 1

| | C₁-C₂ ratio |
|---|---|
| Example 1 | 3.4 |
| Example 2 | 1.7 |
| Example 3 | 2.0 |
| Example 4 | 4.0 |
| Example 5 | 4.3 |
| Comparative | C₂ = 0 |
| Example 1 | (no carbon layer) |

### Experimental Example

### Preparation of Half-Cell

Lithium metal (Li metal) having a thickness of 200 μm was prepared as a negative electrode, positive electrodes each prepared according to Examples and Comparative Examples above were prepared as a positive electrode and a porous substrate (thickness: 15 m) formed of a polyolefin material was prepared as a porous separator. The negative electrode, the separator, and the positive electrode were stacked in that order to prepare an electrode assembly.

The electrode assembly was inserted into a battery case, and then an electrolyte was injected thereto to prepare a half-cell. In this case, as the electrolyte, an electrolyte in which 1 M LiPF₆ was dissolved in a mixed solvent in which ethylene carbonate and dimethyl carbonate were mixed at a volume ratio of 1:1 was used.

### Experimental Example 1: FE-SEM Image of Positive Electrode Active Material

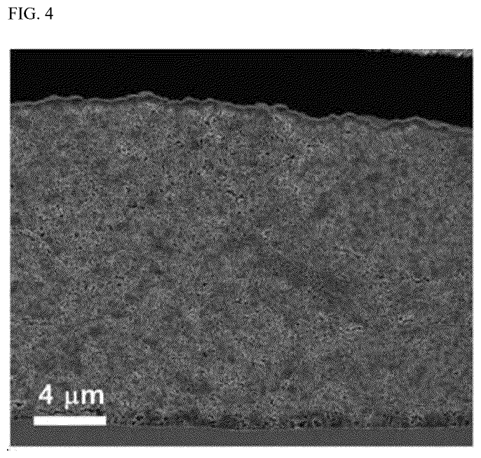

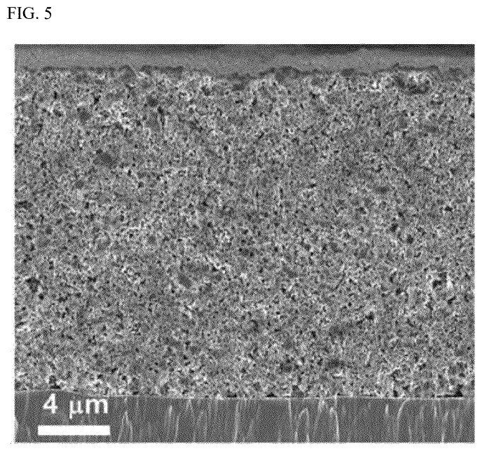

FIG. 4 is a cross-sectional FE-SEM image of a positive electrode prepared according to Example 1, and FIG. 5 is a cross-sectional FE-SEM image of a positive electrode prepared according to Comparative Example 1.

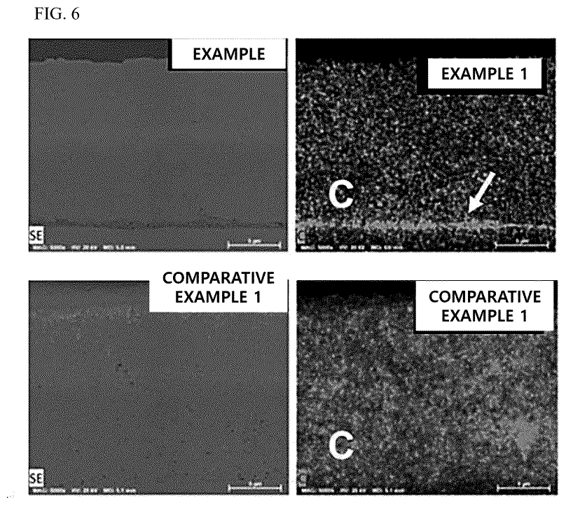

FIG. 6 shows cross-sectional FE-SEM images of positive electrodes according to Example 1 and Comparative Example 1, and distribution of carbon elements in a carbon layer and a positive electrode active material layer included in each positive electrode, analyzed by energy dispersive spectroscopy (EDS).

Referring to FIG. 6, in the positive electrode of Example 1, a carbon layer that is brightly displayed in the EDS analysis image is observed due to the high carbon content, whereas in the positive electrode of Comparative Example 1, such a carbon layer is not observed.

### Experimental Example 2: Electrochemical Property Evaluation

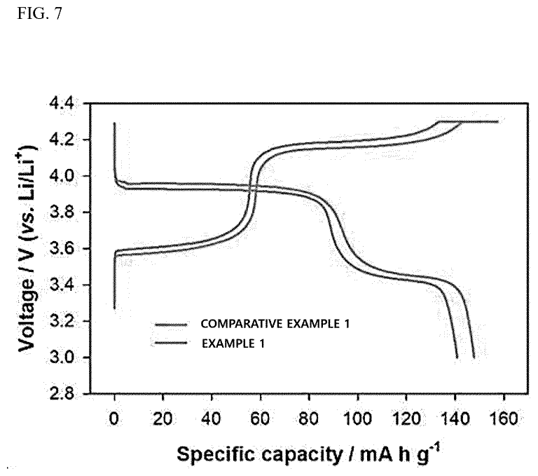

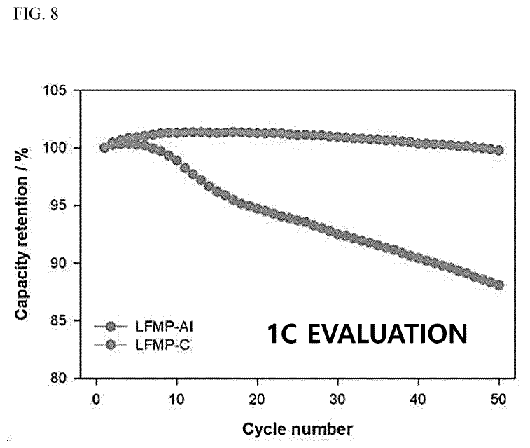

A first cycle voltage-capacity graph (charge/discharge curve) of the half-cell prepared in Experimental Example is shown in FIG. 7, and capacity retention when charging/discharging was performed at a rate of 1 C using the half-cell is shown in FIG. 8.

Referring to FIG. 8, it is seen that the half-cell including the positive electrode according to Example 1 shows capacity retention which remains close to 100% even after 50 cycles, while the half-cell including the positive electrode according to Comparative Example 1 shows capacity retention which falls below 90% after 40 cycles.

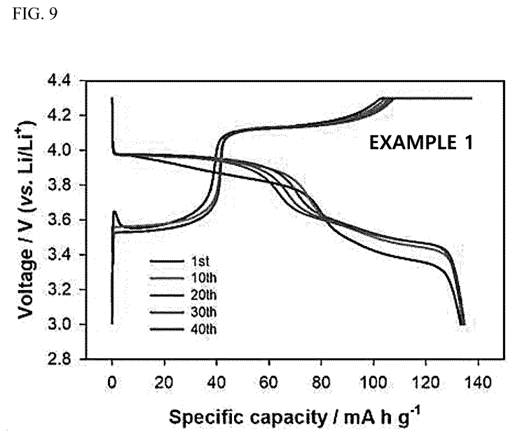

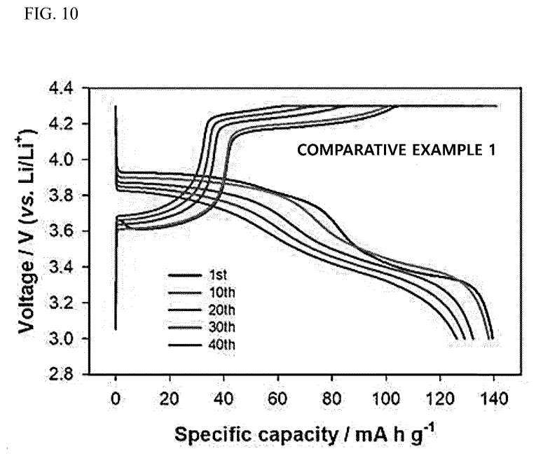

FIGS. 9 and 10 show voltage-capacity graphs (charge/discharge curves) according to the cycle of half-cells including the positive electrode of Example 1 and the positive electrode of Comparative Example 1.

Referring to FIGS. 9 and 10, it is seen that the capacity of the half-cell including the positive electrode of Comparative Example 1 is significantly reduced as overpotential is applied to the half-cell over repeated charging and discharging. However, it is seen that the half-cell including the positive electrode according to Example 1 shows no significant overvoltage despite repeated charging and discharging, and no reduction in battery capacity.

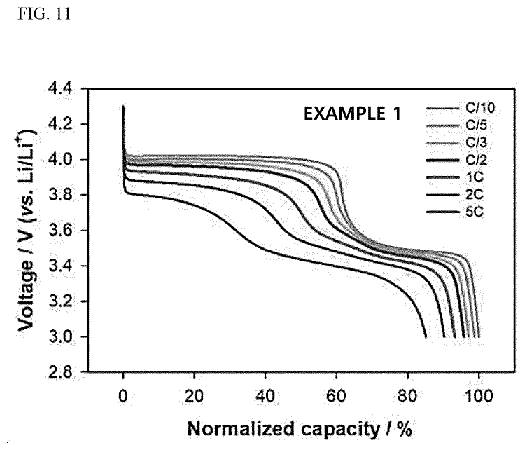

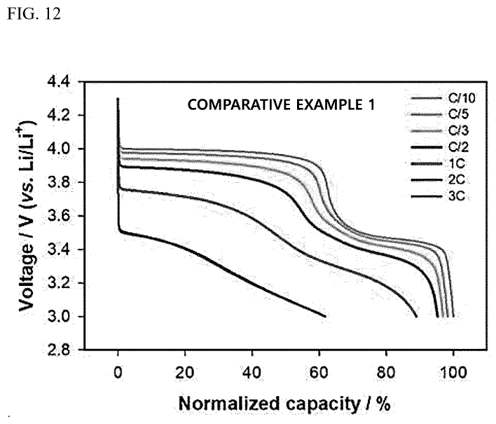

FIG. 11 shows a voltage-capacity graph (charge/discharge curve) obtained by varying the C-rate for the half-cell including the positive electrode of Example 1, and FIG. 12 shows a voltage-capacity graph (charge/discharge curve) obtained by varying the C-rate for the half-cell including the positive electrode of Comparative Example 1.

Referring to FIGS. 11 and 12, it is seen that the half-cell including the positive electrode of Comparative Example 1 had a significant decrease in discharge capacity with increasing current size, but the half-cell including the positive electrode of Example 1 had no significant decrease in capacity even when the current size increased up to 5 C-rate.

In addition, the first cycle capacity and capacity retention of the half-cell were compared according to the carbon ratio C₁/C₂ between the carbon layer and the positive electrode active material layer, and the results are shown in Table 2 below. Referring to Table 2, Examples 1 to 5 regulated the C₁/C₂ ratio by adjusting the carbon content contained in the positive electrode active material layer, and Example 2 having a C₁/C₂ value of less than 2 showed a very low capacity retention. On the contrary, Example 5 having a C₁/C₂ value of greater than 4 is shown to have excellent capacity retention rate, but had a lower capacity of 140 mAh/g in the first cycle than the other Examples. This is believed to be a phenomenon caused by the fact that the carbon layer becomes relatively thick and thus charge transfer resistance increases.

TABLE 2

| | | First cycle | Life retention |
|---|---|---|---|
| | C₁-C₂ | capacity | at 50th cycle |
| | ratio | (mAh/g) | (%) |
| Example 1 | 3.4 | 142.4 | 99.3 |
| Example 2 | 1.7 | 148.1 | 91.1 |
| Example 3 | 2.0 | 145.7 | 98.7 |
| Example 4 | 4.0 | 141.8 | 97.4 |
| Example 5 | 4.3 | 139.1 | 96.5 |
| Comparative | C₂ = 0 | 148.3 | 88.6 |
| Example 1 | (no carbon layer) | | |

Using a positive electrode containing a LiFe_{1-x-y}MnₓM_{y}PO₄-based positive electrode active material according to the present invention, a lithium secondary battery having excellent lifetime and speed characteristics may be provided.

In addition to the effects described above, specific effects of the present invention have been described in the above-detailed description of the embodiments of the present invention.

Although a positive electrode including a LiFeₓMn₁₋ₓPO₄-based positive electrode active material and a lithium secondary battery including the same have been described with reference to the specific embodiments, it (they) is (are) not limited thereto. Therefore, it will be readily understood by those skilled in the art that various modifications and changes can be made thereto without departing from the spirit and scope of the present invention defined by the appended claims.

What is claimed is:

1. A positive electrode for a lithium secondary battery, the positive electrode comprising a carbon layer formed on a positive electrode current collector and a positive electrode active material layer formed on the carbon layer,
wherein the positive electrode active material layer comprises a positive electrode active material according to Formula 1 below,
carbon content contained in the carbon layer and the positive electrode active material layer satisfies Relation 1 below:
LiFe_{1-x-y}MnₓM_{y}PO₄ [Formula 1]
wherein in Formula 1 above, M is at least one metal element selected from the group consisting of Mg, Al, Zn, and Ni, and 0<x<1 and 0≤y<0.1 are satisfied,
$$2 \leq {C}_{1} / {C}_{2} \leq 4 \qquad [ Relation 1 ]$$
wherein in Relation 1 above, C₁ indicates carbon content contained in the carbon layer, and C₂ indicates carbon content contained in the positive electrode active material layer.

2. The positive electrode for a lithium secondary battery of claim 1, wherein the carbon layer has a thickness of 1 nm to 1,000 nm.

3. The positive electrode for a lithium secondary battery of claim 1, wherein the positive electrode active material layer has a thickness of 10 μm to 100 μm.

4. The positive electrode for a lithium secondary battery of claim 1, wherein the carbon layer comprises at least one carbon material selected from the group consisting of natural graphite, artificial graphite, super P, acetylene black, Ketjen black, channel black, furnace black, lamp black, thermal black, denka black, carbon black, graphene, and carbon nanotubes.

5. The positive electrode for a lithium secondary battery of claim 1, wherein the positive electrode active material layer comprises the positive electrode active material, a conductive material, and a binder.

6. The positive electrode for a lithium secondary battery of claim 5, wherein the conductive material contained in the positive electrode active material layer and a carbon material contained in the carbon layer are different.

7. The positive electrode for a lithium secondary battery of claim 1, wherein the positive electrode active material layer and the carbon layer are present at a thickness ratio of 20:1 to 200:1.

8. A lithium secondary battery comprising:
the positive electrode for a lithium secondary battery according to claim 6;
a negative electrode;
an electrolyte; and
a porous separator impregnated into the electrolyte and separating the positive electrode and the negative electrode.
